(19) United States
(12) Patent Application Publication
(10) Pub. No.: US 2026/0326054 A1
(43) Pub. Date: Oct. 22, 2026

(54) PUGMILL SUPPORT SYSTEM

(71) Applicant: Bergkamp Incorporated, Salina, KS (US)

(72) Inventors: Jordan Daniel Reisinger, Salina, KS (US); Jeffrey Tigges, Dubuque, IA (US); Caleb Lee Abell, Solomon, KS (US)

(21) Appl. No.: 19/182,979

(22) Filed: Apr. 18, 2025

(51) Int. Cl. B01F 27/60; B01F 33/502; E01C 19/10; B01F 101/38

(52) U.S. Cl. CPC B01F 27/627; B01F 33/5023; E01C 19/10; B01F 2101/38

(57) ABSTRACT

A system for using a pugmill to mix material. The system comprises a base and the pugmill, which includes at least one mixing element to mix the material. The system additionally includes at least one support arm extending between the base and the pugmill. The support arm is pivotably coupled with the base and pivotably coupled with the pugmill. The system further comprises at least one actuator extending between the base and the pugmill. The actuator is pivotably coupled with the base and pivotably coupled with the pugmill. The system is configured to raise and lower the pugmill between a raised, operating configuration and a lowered, service configuration or cleanout configuration.

### BACKGROUND OF THE INVENTION

### 1. Field of the Invention

The present invention relates to a pugmill configured to mix and discharge material, such as clay, cement, concrete, asphalt, and the like. Specifically, the present invention relates to a pugmill, the position of which, can be shifted between an operating configuration, a service configuration, and a cleanout configuration.

### 2. Description of the Related Art

A pugmill is a type of mixer, in which aggregate may be mixed with water and a binder or emulsion (e.g., bitumen or tar), to form an asphalt mixture. Commonly, the pugmill will be positioned above the ground, such that the asphalt mixture can be discharged from the pugmill to form a stock pile on the ground for future use. For example, an inclining conveyor may convey the aggregate upward from a source (e.g., a bin), above the ground, to be deposited into the pugmill, which as described above, is positioned above the ground. The water and binder/emulsion can likewise be pumped upward, via conduits, to be injected into the pugmill. Commonly, the pugmill is configured as an elongated chamber with rotatable mixing paddles positioned inside for mixing of the asphalt.

Given the height and position of the pugmill above the ground, it can be difficult to access the pugmill to clean out the pugmill after use. t can also be difficult to reach the pugmill for service or maintenance, due to the pugmill be positioned above the ground and being in close proximity to other components associated with the pugmill (e.g., the conveyor, catwalks, etc.). As such, it would be beneficial if there were a system that could support, raise, lower, and/or rotate a pugmill between a raised operating configuration and a lowered cleanout and/or service configuration.

### SUMMARY OF THE INVENTION

One aspect of the present invention concerns a system for using a pugmill to mix material. The system comprises a base and the pugmill, which includes at least one mixing element to mix the material. The system additionally includes at least one support arm extending between the base and the pugmill. The support arm is pivotably coupled with the base and pivotably coupled with the pugmill. The system further comprises at least one actuator extending between the base and the pugmill. The actuator is pivotably coupled with the base and pivotably coupled with the pugmill. The system is configured to raise and lower the pugmill between a raised, operating configuration in which the pugmill is supported above the base and a lowered, service configuration or cleanout configuration.

Another aspect of the present invention concerns a system for using a pugmill to mix material. The system comprises a base and the pugmill, which includes at least one mixing element to mix the material. The system further includes a support assembly configured to raise and lower the pugmill between a raised, operating configuration and a lowered, service configuration and/or a lowered, cleanout configuration. When in the operating configuration, the support assembly is configured to support the pugmill above the base in a generally horizontal orientation. When in the service configuration, the support assembly is configured to support the pugmill in a generally horizontal orientation, with the pugmill being positioned vertically lower than when in the operating configuration. When in the cleanout configuration, the support assembly is configured to support the pugmill in a tilted or a vertical orientation, such that a first end of the pugmill is positioned at a different elevation than a second end of the pugmill.

Another aspect of the present invention concerns a method of using a pugmill. The method comprises a step of supporting the pugmill above a base in a raised, operating configuration to mix the material. During the supporting step, the pugmill is supported in a generally horizontal orientation. An additional step includes lowering the pugmill to a lowered, service configuration to service the pugmill. After the lowering step, the pugmill is supported in a generally horizontal orientation, with the pugmill being positioned vertically lower than when in the operating configuration. A further step includes tilting the pugmill to a lowered, cleanout configuration to clean the pugmill. After the tilting step, a first end of the pugmill is positioned lower than a second end of the pugmill.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE FIGURES

FIG. 1 is a left side, rear perspective view of a mixing system according to embodiments of the present invention, with the mixing system including a trailer, a conveyor, a pugmill, and a support system supporting the pugmill with respect to the trailer;

FIG. 2 is a right side, rear perspective view of the mixing system from FIG. 1;

FIG. 3 is a rear perspective view of the pugmill and support system from FIGS. 1 and 2, with the pugmill and support system separated from the rest of the mixing system;

FIG. 4 is a front perspective view of the pugmill and support system from FIG. 3;

FIG. 5 is a top view of the pugmill from FIGS. 3 and 4, with upper portions removed to illustrate mixing elements in the form of mixing paddles;

FIG. 6 is a side elevation view of a portion of the mixing system from FIGS. 1 and 2, with the pugmill in an operating configuration;

FIG. 7 is a side elevation view of a portion of the mixing system from FIGS. 1 and 2, with the pugmill in a service configuration; and

FIG. 8 is a side elevation view of a portion of the mixing system from FIGS. 1 and 2, with the pugmill in a cleanout configuration.

The figures are not intended to limit the present invention to the specific embodiments they depict. While the drawings do not necessarily provide exact dimensions or tolerances for the illustrated structures or components, the drawings are to scale with respect to the relationships between the components of the structures illustrated in the drawings.

### DETAILED DESCRIPTION

It is noted that the drawings included herewith depict a transportable asphalt mixing system that includes a mobile trailer that supports a pugmill, with a position of the pugmill being shiftable by a pugmill support system. Although the drawings and below description describe a mixing system for asphalt, it should be understood that the mixing system may be used to mix other materials used for the manufacture or repair of roads, such as cement, concrete, and the like. In addition, the mixing system may mix materials that are used for non-road usage, such as clay, soil, or grains or other particulates. Furthermore, the mixing system may, in some embodiments, be a permanently placed system that is not generally transportable.

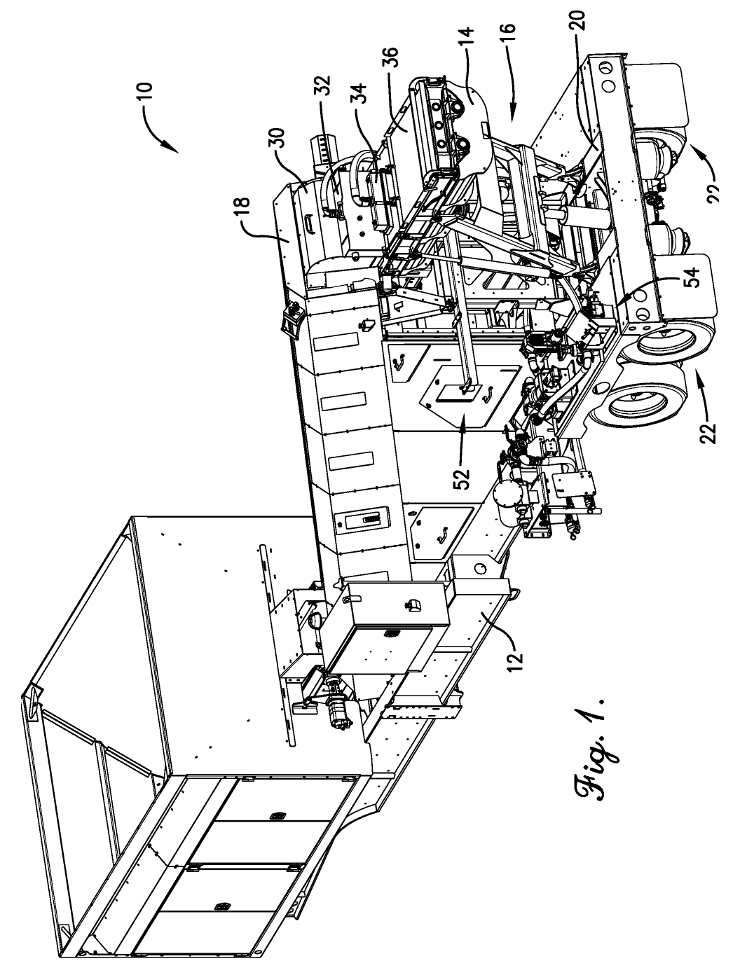

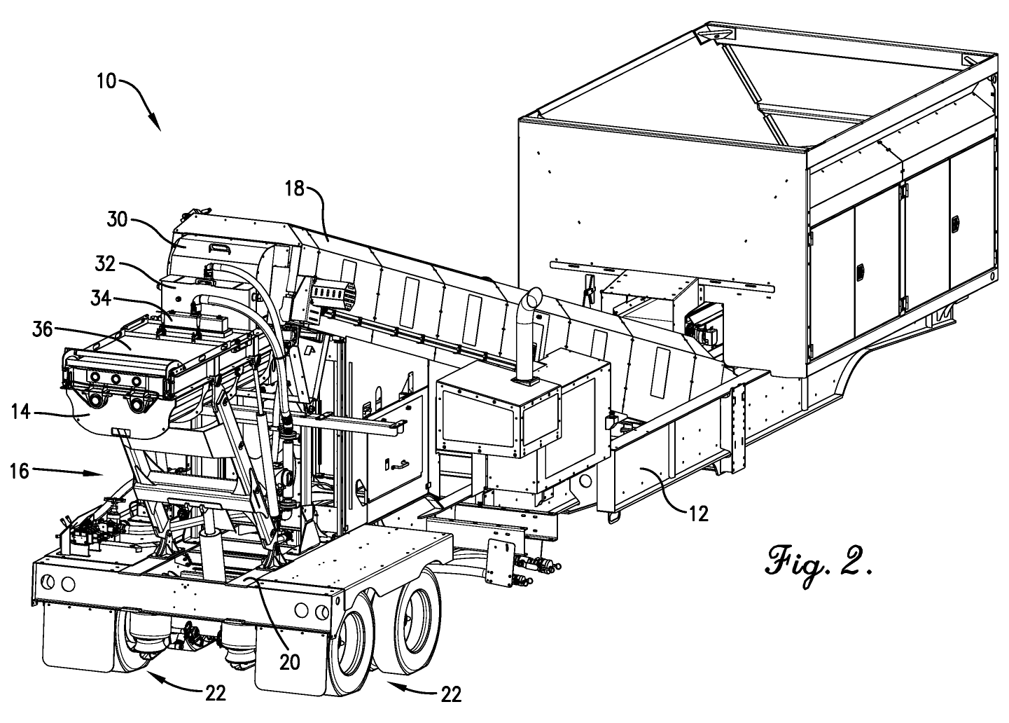

FIGS. 1 and 2 depict a transportable asphalt mixing system 10 that comprises a mobile trailer 12, a pugmill 14 movably supported on the trailer 12 by a pugmill support system 16 (may also be referred to as a support assembly), and a conveyor 18 configured to transport aggregate and to provide the aggregate to the pugmill 14. The trailer 12 may comprise an elongated platform 20, which may be in the form of a base or a frame of the trailer 12, and be configured to support various components of the asphalt mixing system 10. The trailer 12 may be movably supported on the ground by two or more wheels 22. The trailer 12, and the remaining portions of the asphalt mixing system 10, may be moved via a truck or other prime mover towing the trailer 12.

As used herein, directional terms are used with reference to the point of view of an observer standing at a rear end of the asphalt mixing system 10 and facing forward. For example, a rear end of the asphalt mixing system 10 is shown in the lower right corner of FIG. 1 and the lower left corner of FIG. 2. As such, the pugmill 14 is positioned generally at the rear of the trailer 12 and supported above the platform 20 of the trailer 12 by the pugmill support system 16.

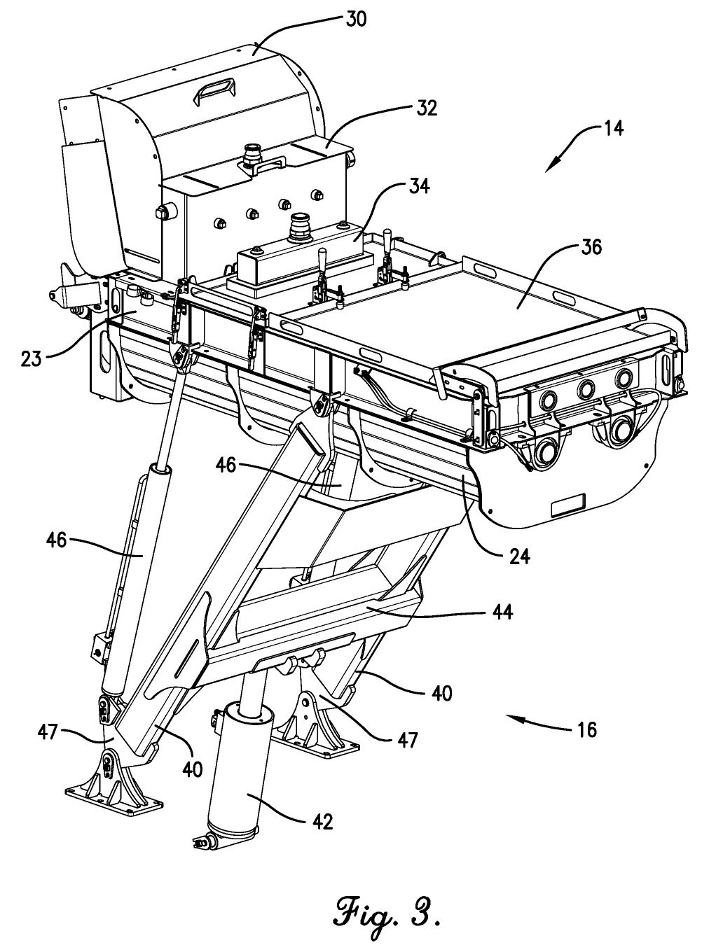

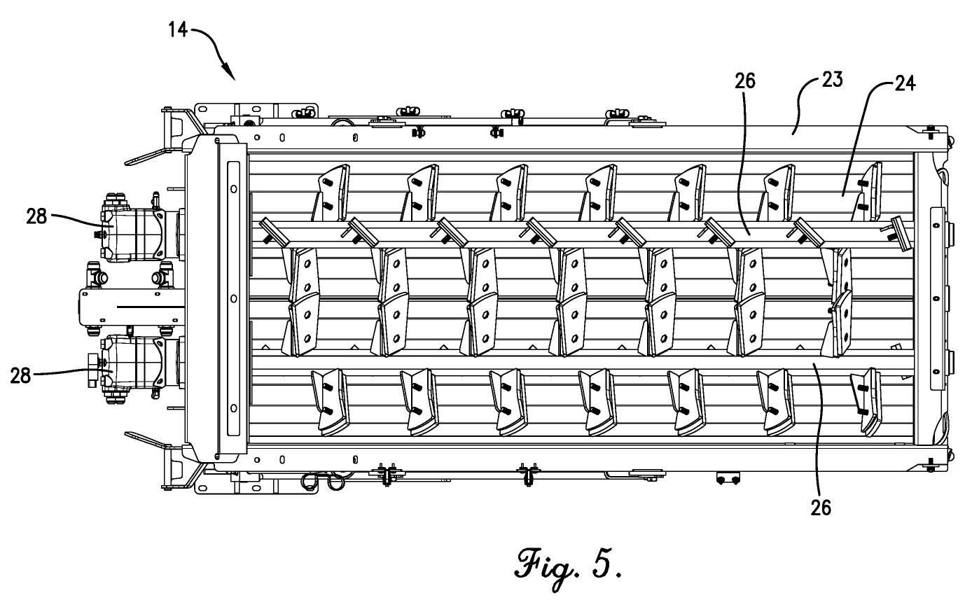

With reference to FIGS. 3-5, the pugmill 14 may comprise an elongated frame 23 to which a lower shell 24 may be removably secured so to provide a box-like container that presents an interior space of the pugmill 14. Within the interior space of the pugmill 14, a pair of elongated mixing elements (e.g., mixing paddles 26 as shown in FIG. 5) are positioned. The mixing paddles 26 may be actuated by hydraulic motors 28 positioned at a front end of the pugmill 14 (see FIGS. 3 and 5). The pugmill 14 may be supported above the trailer 12 by the pugmill support system 16 (described in more detail below), which may extend between the trailer 12 and the pugmill 14, as shown in FIGS. 1 and 2. The pugmill support system 16 may also be referred to and/or function as a support assembly.

Returning to FIGS. 1 and 2, the conveyor 18 may also be supported on the trailer 12 and may extend in an upward direction from front to back, such that the rear end of the conveyor 18 is positioned above the front end of the pugmill 14. As such, the conveyor 18 may transport aggregate upward (e.g., from an unnumbered bin) to be deposited into the pugmill 14 via an aggregate port 30 (see FIGS. 1-3) that connects the rear end of the conveyor 18 to the top of the pugmill 14 at a position adjacent to the front end of the pugmill 14. The aggregate port 30 may be secured to an upper portion of the frame 23 of the pugmill 14. As such, the aggregate port 30 fluidly connects the conveyor 18 with the interior of the pugmill 14. The pugmill 14 may additionally comprise a water port 32 positioned on an upper portion of the frame 23 of the pugmill 14, rearward of the aggregate port 30. The water port 32 may fluidly connect a water conduit of the asphalt mixing system 10 with the interior of the pugmill 14. As such, the mixing system 10 may pump water through the water port 32 into the interior of the pugmill 14. The pugmill 14 may additionally comprise a binder or emulsion port 34 positioned on an upper portion of the frame 23 of the pugmill 14, rearward of the water port 32. The binder or emulsion port 34 may fluidly connect a binder/emulsion conduit of the asphalt mixing system 10 with the interior of the pugmill 14. As such, the mixing system 10 may pump binder/emulsion through the binder or emulsion port 34 into the interior of the pugmill 14. It should be understood, however, that other additives may be provided to and mixed within the pugmill, such as other liquid additives, fiber additives, et. One or multiple access doors 36 may be positioned on an upper portion of the frame 23 of the pugmill 14, rearward of the binder/emulsion port 34, for providing selective access to the interior of the pugmill 14, such as for cleaning and maintenance. Furthermore, in some embodiments, the binder/emulsion port 34 may include and/or be associated with an access door that is hingedly attached to the frame 23 of the pugmill 14, such that the entire binder/emulsion port 34 can be opened or removed from the frame 23 to provide access to the interior of the pugmill 14

In operation, the pugmill 14 will generally be in an operating configuration, as shown in FIGS. 1 and 2, whereby the pugmill 14 is raised, to be spaced above the ground and the platform 20 of the trailer 12. Additionally, in the operating configuration, the pugmill 14 will generally be oriented horizontally (i.e., with a longitudinal axis of the pugmill 14 aligned with horizontal). The height of the pugmill 14 above the ground when in the operating configuration may be from 6 to 10 feet, from 7 to 9 feet, or about 8 feet. In such an operating configuration, aggregate may be provided into the interior of the pugmill 14 by the conveyor 18, via the aggregate port 30. Simultaneously, liquid (e.g., water, a binder or emulsion, and/or other additives) may be injected into the interior of the pugmill 14 by the respective conduits (e.g., via the water port 32 and the binder or emulsion port 34). The aggregate and liquid (e.g., water and binder/emulsion) may be mixed via the mixing paddles 26 (powered by the hydraulic motors 28) to form asphalt, which is ejected from the rear end of the pugmill 14 to form a stock pile of asphalt on the ground behind the asphalt mixing system 10. Alternatively, the asphalt may be ejected from the pugmill 14 into a haul vehicle.

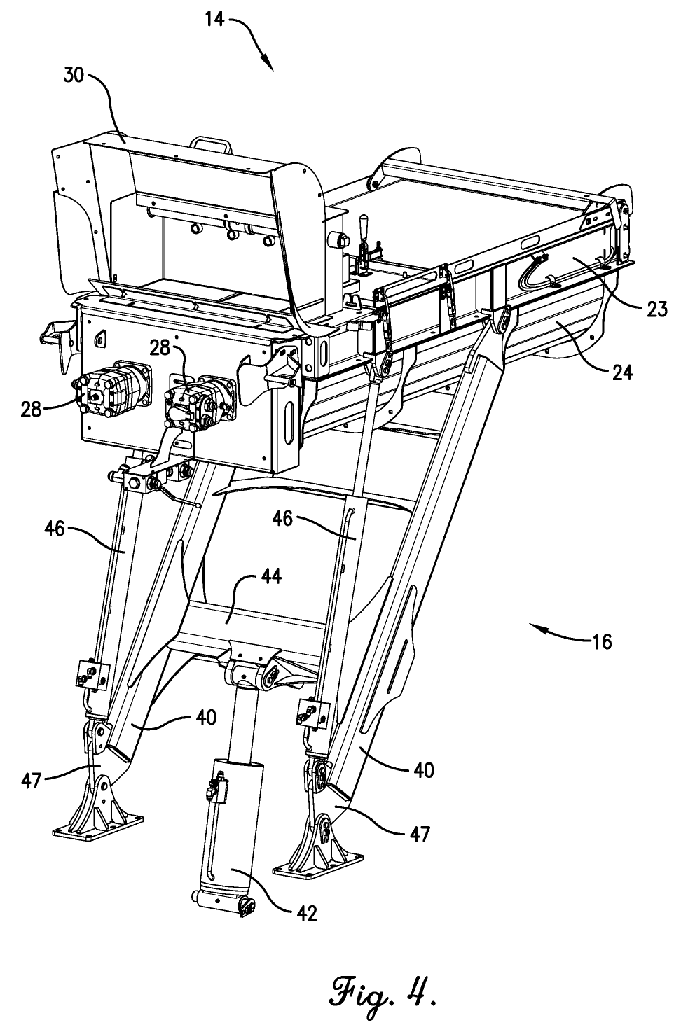

As illustrated in FIGS. 1 and 2, the pugmill 14 is supported on the trailer 12 via the pugmill support system 16, which may comprise a pair of support arms 40 (see FIGS. 3 and 4) that each extend between the platform 20 of the trailer 12 and the pugmill 14. Specifically, a first support arm 40 may be pivotably attached to a top support surface of the platform 20 adjacent to a left side of the trailer 12. The first support arm 40 may extend to a left side of the pugmill 14, where the first support arm 40 is pivotably attached to the left side of the frame 23 of the pugmill 14. The first support arm 40 may be pivotably connected with the frame 23 of the pugmill 14 generally centrally with respect to a longitudinal direction of the pugmill 14. Similarly, a second support arm 40 may be pivotably attached to the top support surface of the platform 20 adjacent to a right side of the trailer 12. The second support arm 40 may extend to a right side of the pugmill 14, where the second support arm 40 is pivotably attached to the right side of the frame 23 of the pugmill 14. The second support arm 40 may be pivotably connected with the frame 23 of the pugmill 14 generally centrally with respect to the longitudinal direction of the pugmill 14.

Remaining with FIGS. 3 and 4, the pugmill support system 16 may additionally include a lift actuator 42 that is configured to raise and lower the support arms 40, and thus, raise and lower the pugmill 14. In more detail, the pugmill support system 16 may comprise a crossmember 44 extending laterally between the first and second support arms 40. The cross member 44 may be positioned vertically between upper and lower ends of the support arms 40 when the pugmill 14 is in the operating configuration. As such, the lift actuator 42 may extend between the platform 20 of the trailer 12 and the crossmember 44. Specifically, the lift actuator 42 may be pivotably attached to the platform 20 (centrally positioned in a lateral direction on the platform 20), and may extend to the crossmember 44 where the lift actuator 42 is pivotably attached to the crossmember 44 (centrally positioned in a lateral direction on the crossmember 44). It is noted that the lift actuator 42 may be pivotably attached to the platform 20 of the trailer 12 at a lower position than where the support arms 40 are attached to the platform 20. The lift actuator 42 may comprise various types of linear or rotary actuators, such as a hydraulic cylinder. As such, the lift actuator 42 may extend from a retracted position to raise the support arms 40, and thus, the pugmill 44. Correspondingly, the lift actuator 42 may retract from an extended position to lower the support arms 40, and thus, the pugmill 14. Regardless, the lift actuator 42 may comprise other types of actuators, such as a rotary actuator, and may also be powered electrically or pneumatically.

Furthermore, the pugmill support system 16 may comprise a pair of tilt actuators 46 that each extend between the platform 20 of the trailer 12 and the pugmill 14. Specifically, a first tilt actuator 46 may be pivotably attached to the top support surface of the platform 20 of the trailer 12 adjacent to a left side of the trailer 12. The first tilt actuator 46 may extend to a left side of the pugmill 14, where the first tilt actuator 46 is pivotably attached to the left side of the frame 23 of the pugmill 14. Each of the first tilt actuator 46 and the first support arm 40 may be pivotably connected to the platform 20 of the trailer 12 via a common support plate 47. Specifically, the first tilt actuator 46 and the first support arm 40 may be pivotably connected to support plate 47, and the support plate 47 may itself be pivotally connected to the platform 20 of the trailer 12. The first tilt actuator 46 may be pivotably connected with the frame 23 of the pugmill 14 rearward (in a longitudinal direction) from where the first support arm 40 connects with the left side of the frame 23 of the pugmill 14.

Similarly, a second tilt actuator 46 may be pivotably attached to the top support surface of the platform 20 of the trailer 12 adjacent to a right side of the trailer 12. The second tilt actuator 46 may extend to a right side of the pugmill 14, where the second tilt actuator 46 is pivotably attached to the right side of the frame 23 of the pugmill 14. The second tilt actuator 46 may be pivotably connected with the frame 23 of the pugmill 14 rearward (in a longitudinal direction) from where the second support arm 40 connects with the right side of the pugmill 14. Each of the second tilt actuator 46 and the second support arm 40 may be pivotably connected to the platform 20 of the trailer 12 via a common support plate 47. Specifically, the second tilt actuator 46 and the second support arm 40 may be pivotably connected to the support plate 47, and the support plate 47 may itself be pivotally connected to the platform 20 of the trailer 12.

The tilt actuators 46 may comprise various types of linear or rotary actuators, such as hydraulic cylinders. As such, and as will be described in more detail below, the tilt actuators 46 may extend from a retracted position to tilt the front end of the pugmill 14 rearward, such that the rear end of the pugmill 14 is at a different elevation (e.g., positioned lower) than the front end of the pugmill 14. Correspondingly the tilt actuators 46 may retract from an extended position to tilt the front end of the pugmill 14 forward, such that the rear end of the pugmill 14 is positioned in horizontal alignment with the front end of the pugmill 14. Regardless, the tilt actuators 46 may comprise other types of actuators, such as rotary actuators, and may be powered electrically or pneumatically.

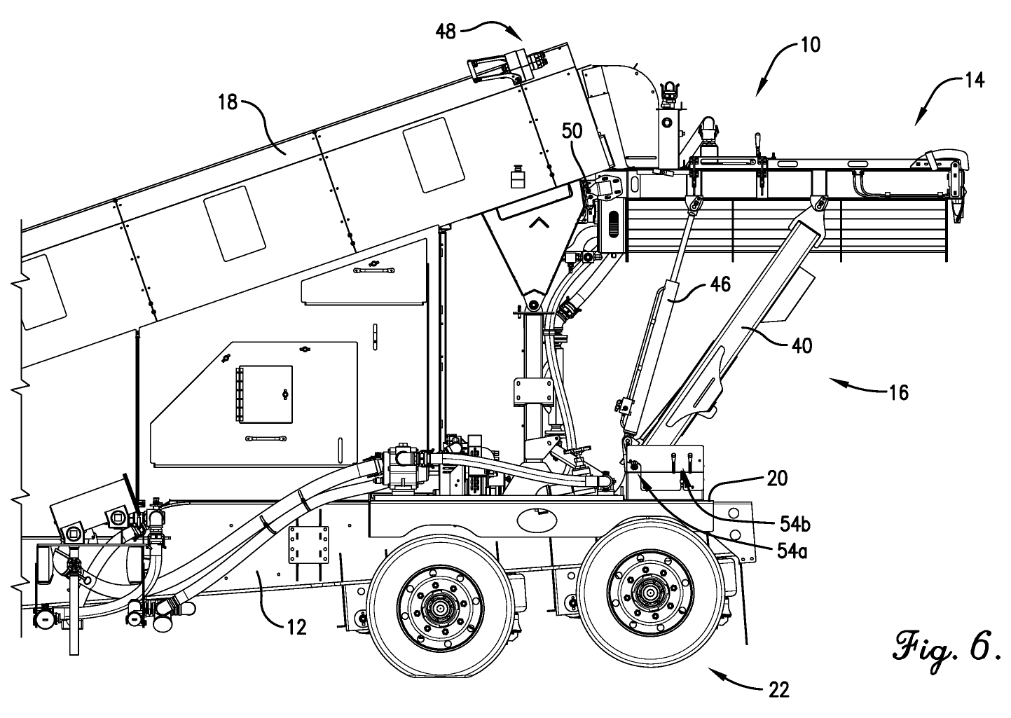

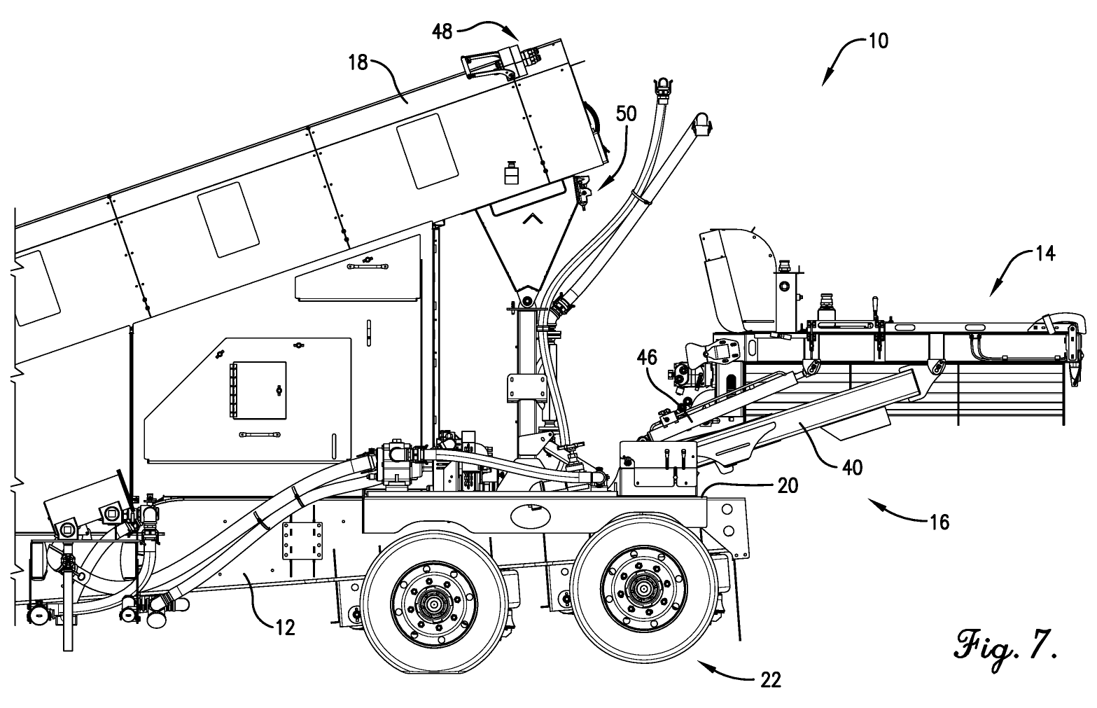

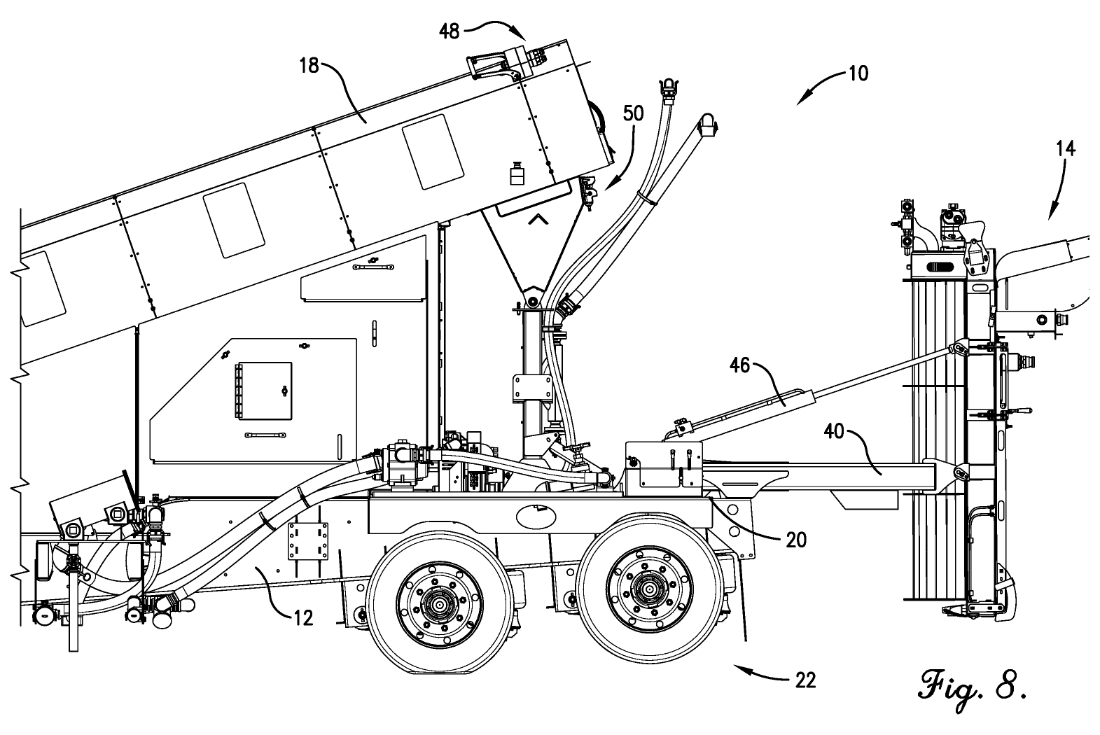

In view of the above, the pugmill support system 16 is configured to support and transition the pugmill 14 between three configurations, namely, the raised operating configuration (see FIG. 6), a lowered service configuration (see FIG. 7), and a lowered cleanout configuration (see FIG. 8). In the operating configuration shown in FIG. 6, the pugmill 14 is supported at a first raised height above the top surface of the platform 20 of the trailer 12 in a generally horizontal orientation (i.e., with a longitudinal axis of the pugmill 14 being parallel with horizontal). The pugmill 14 is supported in such an operating configuration by the pugmill support system 16 via the lift actuator 42 being in an extended position and each of the tilt actuators 46 being in a partially extended position. In certain embodiments, the pugmill 14 may be restricted from being lowered from the operating configuration by a hydraulic hose coupler 48 shown in FIGS. 6-8, the functionality of which will be described further below. The pugmill 14 may be further retained in the operating configuration via a hydraulically operated latching mechanism 50 that selectively locks the pugmill 14 in position with respect to frame elements of the trailer 12, as will be described in more detail below.

In the operating configuration, the pugmill 14 can receive (i) aggregate from the conveyor 18, (ii) water from the water conduit, and (iii) binder/emulsion from the binder/emulsion conduit, and mix all of such components together via the mixing paddles 26 (see FIG. 5) to form asphalt that can be ejected from the rear end of the pugmill 14. Given the height of the pugmill 14 in the operating configuration (see again FIG. 6), the ejected asphalt can be ejected rearward from the pugmill 14 (and rearward of the entire asphalt mixing system 10) to form a stock pile of asphalt on the ground. Users of the asphalt can then collect asphalt from the stock pile for further use (e.g., for paving roadways). Alternatively, the asphalt may be ejected from the pugmill 14 into a haul vehicle for transport.

The pugmill support system 16 is configured to lower the pugmill 14 from the operating configuration to the service configuration (see FIG. 7) by retracting the lift actuator 42 to a retracted position. Likewise, the tilt actuators 46 may be retracted to retracted positions. The height of the pugmill 14 above the ground when in the service configuration may be from 2 to 6 feet, from 3 to 5 feet, or about 4 feet or about 4.5 feet (or from one-fourth to three-fourths the height of the pugmill 14 in the operating configuration, or about one-half the height of the pugmill 14 in the operating configuration). As such, in the service configuration, the pugmill 14 is supported at a second raised height above the top surface of the platform 20 of the trailer 12 in a generally horizontal orientation (i.e., with a longitudinal axis of the pugmill 14 being parallel with horizontal). As illustrated, the second raised height of the pugmill 14 is lower than the first raised height of the pugmill 14 when in the operating configuration. The pugmill 14 is supported in such a service configuration by the pugmill support system 16 via the lift actuator 42 being in the retracted position and each of the tilt actuators 46 also being in the retracted position. In certain embodiments, when in the service configuration, the support arms 40 will be oriented in an angle between vertical and horizontal. In embodiments that include the hydraulic hose coupler 48 and the hydraulically operated latching mechanism 50, such mechanism 50 may need to be unlocked before the pugmill 14 can be shifted from the operating configuration to the service configuration. The hydraulic hose coupler 48 may connect hydraulic hoses from a hydraulic power system 52 (e.g., hydraulic pump/motor, flywheel, hydraulic tank, etc.) of the asphalt mixing system 10 (see FIG. 1) to the hydraulic motors 28 of the pugmill 14. The hydraulic hose coupler 48 may comprise a hydraulic quick connect/disconnect with a lever, which when actuated to a release position, disconnects the hydraulic hoses that extend from the hydraulic motors 28 to the hydraulic power system 52. The hydraulic hoses that extend from the hydraulic motors 28 are required to be disconnected from the hydraulic hose coupler 48 before the pugmill 14 can be lowered from the operating configuration. Furthermore, the hydraulic hose coupler 48 is in communication with the latching mechanism 50, such that the latching mechanism 50 cannot be unlatched until the hydraulic hose coupler 48 is actuated to the release position. In addition, the water and binder/emulsion conduits may need to be disconnected from the respective ports 32, 34 before the pugmill’s 14 position can be shifted.

In the service configuration, the pugmill 14 can be more readily accessed for maintenance and repair. For instance, due to the reduced height of the pugmill 14, users of the asphalt mixing system 10 can more easily access the shell 24, the mixing paddles 26 (see FIG. 5), the hydraulic motors 28 (see FIG. 4), the aggregate port 30 (see FIG. 3), the water port 32 (see FIG. 3), the binder/emulsion port 34 (see FIG. 3), the doors 36 (see FIG. 3), and other components of the pugmill 14 that may require frequent maintenance or repair. For example, the mixing paddles 26 may need to be frequently removed from the pugmill 14 to be serviced or replaced with new mixing paddles 26. With the pugmill 14 in the service configuration, the mixing paddles 26 can be readily accessed and removed by detaching and extracting the mixing paddles from the frame 23 of the pugmill 14 (e.g., by pulling the mixing paddles 26 rearward, in a longitudinal direction, from the rear end of the pugmill 14). Regardless, it should be understood that many of the components of the pugmill 14 may be disconnected or removed from the frame 23 to facilitate cleaning, service, and maintenance, such as the shell 24, the mixing paddles 26, the hydraulic motors 28, the aggregate port 30, the water port 32, the binder/emulsion port 34, the doors 36, the support arms 40, and/or the tilt actuators 46.

Furthermore, as shown in FIG. 8, the pugmill support system 16 is configured to tilt the pugmill 14 rearward from the service configuration to the cleanout configuration by extending the tilt actuators 46 to fully extended positions. The lift actuator 42 may remain in the retracted position. As such, the front end of the pugmill 14 will rotate forward about the pivot connections connecting the support arms 40 and the pugmill 14, such that the front end of the pugmill 14 is raised and the rear end of the pugmill 14 is lowered. As such, the front end of the pugmill 14 will be at a higher position than the rear end of the pugmill 14. In some embodiments, when the pugmill 14 is in the cleanout configuration, the pugmill 14 will be oriented vertically (i.e., with a longitudinal axis of the pugmill 14 being parallel with vertical), such that the front end of the pugmill 14 is position directly above the rear end of the pugmill 14. The height of the pugmill 14 above the ground when in the cleanout configuration may be from 0.5 to 3 feet, from 1 to 2 feet, or about 0.5 feet, about 1 foot, or about 1.5 feet. The pugmill 14 is supported in such a cleanout configuration by the pugmill support system 16 via the lift actuator 42 being in the retracted position and each of the tilt actuators 46 being in the fully extended position. In certain embodiments, when in the cleanout configuration, the support arms 40 will be oriented horizontally. In embodiments that include the hydraulically operated latching mechanism 50, such mechanism may need to be unlocked before the pugmill 14 can be shifted from the operating configuration to the cleanout configuration. In addition, the hydraulic hoses that extend from the hydraulic motors 28 must be disconnected from the hydraulic hose coupler 48, and the water and binder/emulsion conduits may need to be disconnected from the respective ports 32, 34 before the pugmill’s 14 position can be shifted.

In the cleanout configuration, the pugmill 14 can be readily accessed at a preferential height for cleaning, particularly after being used to mix asphalt in the operating configuration. Specifically, the one or more doors 36 (see FIG. 3) on the top side of the frame 23 of the pugmill 14 (now directed rearward) can be opened or removed to provide access to the interior of the pugmill 14. As such, water and/or cleaning solutions can be sprayed into the interior of the pugmill 14 to clean the interior of the pugmill 14 and/or the mixing paddles 26 of any asphalt (or remaining aggregate, water, or binder/emulsion) that remain within the pugmill 14 after operation. Cleaning of the pugmill 14 may be performed by scraping the interior of the pugmill 14 (e.g., scraping interior walls, paddles, and doors) via electric chisels, hand chisels, putty knives, etc. Torch heat may also be applied to the interior to soften any remaining asphalt within the pugmill 14. Beneficially, the waste from the pugmill 14 can flow directly downward and fall out of the rear end of the pugmill 14 onto the ground for efficient removal. In addition, the aggregate port 30 (see FIG. 3), the water port 32 (see FIG. 3), the binder/emulsion port 34 (see FIG. 3) can be accessed and/or removed from the frame 23to facilitate efficient cleaning of the pugmill 14 (e.g., the shell 24, the mixing paddles 26, and/or the ports 30, 32, 34).

Upon being cleaned when in the cleanout orientation, the pugmill 14 can be transitioned back to service configuration and/or to the operating configuration. To initially transition to the service configuration, each of the tilt actuators 46 may be retracted from the fully extended positions to the retracted positions such that the front end of the pugmill 14 rotates about the pivot connections between the support arms 40 and the pugmill 14 until the front end of the pugmill 14 is level with the rear end of the pugmill 14 (i.e., the longitudinal axis of the pugmill 14 is parallel with horizontal). To then transition to the operating configuration, the lift actuator 42 may extend from the retracted position to the extended position, such that the pugmill 14 is raised from the second raised height to the first raised height. The tilt actuators 46 may also be extended to the partially extended position. The pugmill 14 may be secured at the first raised height of the operating configuration by the hydraulically operated latching mechanism 50. In the operating configuration, the pugmill 14 can again be used to mix asphalt, as has been previously described.

Returning to FIG. 1, the asphalt mixing system 10 may include the hydraulic power system 52 configured to provide hydraulic power to the various components of the system 10. For example, the hydraulic power system 52 may selectively provide power (i) to the conveyor 18 that provides aggregate to the pugmill 14, (ii) to pumps that provide water and binder/emulsion to the pugmill 14 via the associated conduits, (iii) to the motors 28 that power the mixing paddles 26 of the pugmill 14, (iv) to the latching mechanism 50 that secures the pugmill 14 in the operating configuration, and/or (v) to the lift actuator 42 and the tilt actuators 46 that move the pugmill 14 between the operating, service, and cleanout configurations. The hydraulic power system may be supported on the trailer 12.

In some embodiments the asphalt mixing system 10 may also include a control panel 54, as shown in FIG. 1, for controlling the lift actuator 42 and the tilt actuators 46 to thereby selectively move the pugmill 14 between the operating, service, and cleanout configurations. The control panel 54 may be supported on the trailer 12 and may include, as shown in FIG. 6, a palm button 54a and a pair of levers 54b. A first lever of the pair 54b may be configured to selectively provide hydraulic power from the hydraulic power system 52 to the lift actuator 42 to extend and/or retract the lift actuator 42. The second lever of the pair 54b may be configured to selectively provide hydraulic power from the hydraulic power system 52 to the tilts actuators 46 to extend and/or retract the tilt actuators 46. As such, the first and second levers may be manipulated to transition the pugmill 14 between the operating, service, and cleanout configurations. In certain embodiments, an operator may be required to depress the palm button 54a before the first or second levers are operable to actuate the lift actuator 42 or the tilt actuators 46. In some embodiments, the palm button 54a may be required to be depressed only when the pugmill 14 is being lowered by the lift actuator 42. In addition, depression of the palm button 54a may be required to release the latching mechanism 50 (if the hydraulic hose coupler 48 has also been released). In some embodiments, the palm button 54a may not need to be depressed to raise or to tilt the pugmill 14. The requirement of the palm button 54a to be depressed when lowering the pugmill 14 necessitates the operator’s use of two hands to perform the lower operation (i.e., one hand on the palm button 54a and one hand on the first lever of the pair of levers 54b). Such functionality prevents unintentionally lowering, such as if the first lever is bumped or otherwise inadvertently actuated.

Furthermore, because the motors 28 are hydraulically disconnected from the hydraulic power system 52 prior to the pugmill 14 being lowered, the motors 28 cannot inadvertently power the mixing paddles 26 when the pugmill 14 is lowered for service or cleanout. In certain other embodiments, the motors 28 of the pugmill 14 may be associated with a port that allows the motors 28 to be cross-ported, which allows the motors 28 and the mixing paddles 14 to freely spin during service or cleanout.

### CLAIMS NOT LIMITED TO DISCLOSED EMBODIMENTS

Although specific embodiments of the present technology have been illustrated and described herein. The following claims should not be limited to specific features described and illustrated in this description, unless the claims expressly require those specific features. For example, although the mixing system described herein has generally referred to the mixing of asphalt, the mixing system could be used for other materials, such as cement, concrete, clay, soil, grains, other particulates, etc. In addition, although the mixing system described herein primarily describes the system being transportable on a trailer, embodiments may include the mixing system being part of a permanent or semi-permanent structure.

In addition, although the present disclosure primarily discloses the pugmill being shiftable between operating, service, and cleanout configurations, it is contemplated that the pugmill may also be positioned in other configurations. Generally, the pugmill will be operated at an increased height for operation and may be lowered to various positions (i.e., lower than the operating height) for cleanout, service, maintenance, and the like. Furthermore, although the present disclosure uses the terms operating, service, and cleanout when referring to particular configurations, such terms should not be interpreted to be limiting of the functionality of the pugmill. For example, the pugmill may be cleaned out when in the service configuration and may be serviced when in the cleanout configuration.

Furthermore still, the pivot connections that connect the pugmill with the support arms and the tilt actuators may be released (e.g., by removing associated pivot pins), such that the pugmill can be entirely separated from the rest of the mixing system. For instance, a forklift, telehandler, crane, or other lifting system may be used to separate the pugmill from the rest of the mixing system to facilitate service or cleanout of the pugmill. Notably, such removal of the pugmill can be preferentially performed (e.g., by a forklift) when the pugmill is lowered from the raised, operation operating to a lower, more accessible position (e.g., when in the service configuration).

What is claimed is:

1. A system for using a pugmill to mix material, said system comprising:
base;
the pugmill, with the pugmill including at least one mixing element to mix the material;
at least one support arm extending between the base and the pugmill, wherein the support arm is pivotably coupled with the base and pivotably coupled with the pugmill; and
at least one actuator extending between the base and the pugmill, wherein the actuator is pivotably coupled with the base and pivotably coupled with the pugmill,
wherein the system is configured to raise and lower the pugmill between a raised, operating configuration in which the pugmill is supported above the base and a lowered, service configuration or cleanout configuration.

2. The system of claim 1, wherein the support arm is a first support arm pivotably coupled with a first side of the pugmill, and wherein the system further includes a second support arm pivotably coupled with the base and pivotably coupled with a second side of the pugmill.

3. The system of claim 2, further comprising a lift actuator configured to raise and lower the pugmill by raising and lowering the first and second support arms.

4. The system of claim 3, wherein a crossmember extends between the first and second support arms, wherein the lift actuator extends between the base and the crossmember, and wherein the lift actuator is pivotably coupled with the base and pivotably coupled with the crossmember.

5. The system of claim 4, wherein the lift actuator comprises a hydraulic cylinder.

6. The system of claim 1, wherein the at least one actuator is a first tilt actuator configured to tilt the pugmill such that a first end of the pugmill is at a different elevation than a second end of the pugmill.

7. The system of claim 6, wherein the first tilt actuator is pivotably coupled with a first side of the pugmill, and wherein the system further includes a second tilt actuator pivotably coupled with the base and pivotably coupled with a second side of the pugmill.

8. The system of claim 7, wherein the first and second tilt actuators each comprises a hydraulic cylinder.

9. The system of claim 1, wherein the base comprises a wheeled trailer.

10. The system of claim 1, wherein the material comprises asphalt.

11. A system for using a pugmill to mix material, said system comprising:
a base;
the pugmill, wherein the pugmill includes at least one mixing element to mix the material; and
a support assembly configured to raise and lower the pugmill between a raised, operating configuration and a lowered, service configuration and/or a lowered, cleanout configuration,
wherein in the operating configuration, the support assembly is configured to support the pugmill above the base in a generally horizontal orientation,
wherein in the service configuration, the support assembly is configured to support the pugmill in a generally horizontal orientation, with the pugmill being positioned vertically lower than when in the operating configuration,
wherein in the cleanout configuration, the support assembly is configured to support the pugmill in a tilted or vertical orientation, such that a first end of the pugmill is positioned at a different elevation than a second end of the pugmill.

12. The system of claim 11, wherein the support assembly comprises at least one support arm extending between the base and the pugmill, wherein the support arm is pivotably coupled with the base and pivotably coupled with the pugmill, and wherein the support assembly further comprises at least one lift actuator configured to raise and lower the pugmill by raising and lowering the support arm.

13. The system of claim 12, wherein the support assembly further comprises a tilt actuator extending between the base and the pugmill, wherein the tilt actuator is pivotably coupled with the base and pivotably coupled with the pugmill, and wherein the tilt actuator is configured to tilt the pugmill such that a first end of the pugmill is at a different elevation than a second end of the pugmill.

14. A method of using a pugmill, said method comprising:
(a) supporting the pugmill above a base in a raised, operating configuration to mix material, wherein during the supporting of step (a), the pugmill is supported in a generally horizontal orientation;(b) lowering the pugmill to a lowered, service configuration to service the pugmill, wherein upon the lowering of step (b), the pugmill is supported in a generally horizontal orientation; and(c) tilting the pugmill to a lowered, cleanout configuration to clean the pugmill, wherein upon the tilting of step (c), a first end of the pugmill is positioned lower than a second end of the pugmill.

15. The method of claim 14, wherein the supporting, lowering, and tilting of steps (a), (b), and (c), are performed by a support assembly comprising at least one support arm extending between the base and the pugmill, wherein the support arm is pivotably coupled with the base and pivotably coupled with the pugmill, and wherein the support assembly further comprises at least one lift actuator configured to raise and lower the pugmill by raising and lowering the support arm.

16. The method of claim 15, wherein when the pugmill is in the cleanout configuration, the support arm is oriented generally horizontally, and wherein when the pugmill is in the service configuration, the support arm is orientated at an angle between horizontal and vertical.

17. The method of claim 15, wherein the support assembly further comprises a tilt actuator extending between the base and the pugmill, wherein the tilt actuator is pivotably coupled with the base and pivotably coupled with the pugmill, and wherein the tilt actuator is configured to tilt the pugmill during said tilting of step (c).

18. The method of claim 14, wherein the material being mixed comprises aggregate and a liquid, and wherein during said supporting of step (a) the aggregate is introduced into the pugmill via a conveyor.

19. The method of claim 18, wherein during said supporting of step (a) the pugmill is configured to discharge mixed material (i) downward to form a stock pile of mixed material, or (ii) into a haul vehicle.

20. The method of claim 14, wherein during said supporting of step (a) the pugmill is configured to mix the material via one or more mixing elements extending at least partially through the pugmill.
